(19) United States
(12) Patent Application Publication
(10) Pub. No.: US 2012/0317033 A1
(43) Pub. Date: Dec. 13, 2012

(54) GENERATING BUSINESS PROCESS OBJECTS

(76) Inventor: ROBERT HEIDASCH, Speyer (DE)

(21) Appl. No.: 13/157,326

(22) Filed: Jun. 10, 2011

(51) Int. Cl. G06F 21/00; G06Q 10/00

(52) U.S. Cl. 705/51; 705/301

(57) ABSTRACT

Various embodiments of systems and methods for generating a business process object for integrating business process and business objects associated with a business activity are described herein. One or more business process definitions of a business activity are received from a business process model. Also, one or more business object instances used to execute the one or more business process definitions are retrieved from a business object model. Further, the business process object is generated by encapsulating the received one or more business process definitions and the retrieved one or more business object instances. Furthermore, during runtime, business process object data associated with the business process object is transferred to a business application client system using a transfer session key and business object specific way of encryption and decryption methods.

### FIELD

Embodiments generally relate to computer systems and more particularly to methods and systems for generating a business process object for integrating business process and business objects associated with a business activity.

### BACKGROUND

Typical business activities are business process oriented as well as business object based activities. A typical business process defines a set of steps (e.g., user interface (UI) elements) associated with a business activity at a business process model. Furthermore, a typical business object in a business object model encapsulates business object data used to execute the business process. In contemporary methods, the business object model is exposed separately to a business application client system for executing the business process. In other words, a gap exists while extracting the business object data required for the business process. In a complex business process (i.e., the cross-application business process), the business object data can be saved in many business applications or systems that participate in a particular business process, thereby increasing the complexity of the integration between the business process and the business objects.

In addition, the security of sensitive business object data plays a role in configuring and maintaining such a system. Different security methods such as symmetric encryption, asymmetric encryption, hybrid encryption, message authentication code, digital signature, and the like are used to transfer the business object data from the business object model to the business application client system. Also, the modular data transfer is employed to optimize the business object data that is transferred. However, such methods may fail if an insider, who is authenticated for performing a business activity, tries to hack other business object data which is of the same type (e.g., same business objects used to perform the different business activities).

Therefore, it is desirable to provide a simple integration model to integrate both the business process and the business objects used to execute the business process. And, to provide a secure business object data transfer during the integration of business process and the business objects.

### SUMMARY

Various embodiments of systems and methods for generating a business process object for integrating business process and business objects associated with a business activity are described herein. In one aspect, one or more business process definitions of a business activity are received from a business process model. Also, one or more business object instances used to execute the one or more business process definitions are retrieved from a business object model. Further, the business process object is generated by encapsulating the received one or more business process definitions and the retrieved one or more business object instances. Furthermore, during runtime, business process object data associated with the business process object is transferred to a business application client system using a transfer session key and business object specific way of encryption and decryption methods.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow diagram illustrating a method for generating a business process object, according to an embodiment.

FIG. 2 is an architectural block diagram of a system to execute the method of FIG. 1, according to an embodiment.

FIG. 3 is a block diagram illustrating a business process object, according to an embodiment.

FIG. 4 is a block diagram illustrating an overview of an integrating system for integrating business process and business objects associated with a business activity, according to an embodiment.

FIG. 5 is a block diagram illustrating a system for transferring business process object data from a business process object to a business application client system, according to an embodiment.

FIG. 6 is a sequence diagram illustrating a data flow for transferring business process object data from a business process object to a business application client system, according to an embodiment.

FIG. 7 is a block diagram illustrating a computing environment in which the techniques described for integrating business process and business object based business activities, according to an embodiment.

### DETAILED DESCRIPTION

Embodiments of techniques for generating a business process object to integrate business process and business objects associated with a business activity are described herein. A typical business process consists of a list of sequential and parallel business process steps or business process definitions. The business process definitions serve to separate the overall business process into parts. The business process definition is self-contained and serves a well defined business purpose. The business process is executed on top of one or more business objects. Further, business processes may be bound to a business activity. Therefore, the business activities are business process and business object based activities. In one embodiment, a business process object is generated to integrate business process and business objects of a business activity.

According to an embodiment, business process definitions of a business activity are received from a business process model. Also, business object instances are retrieved from a business object model to execute the one or more business process definitions. Further, the business process object is generated by encapsulating the received one or more business process definitions and the retrieved one or more business object instances. Furthermore, business process object data associated with the business process object is transferred to a business application client system using a transfer session key and business object specific way of encryption and decryption methods.

In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

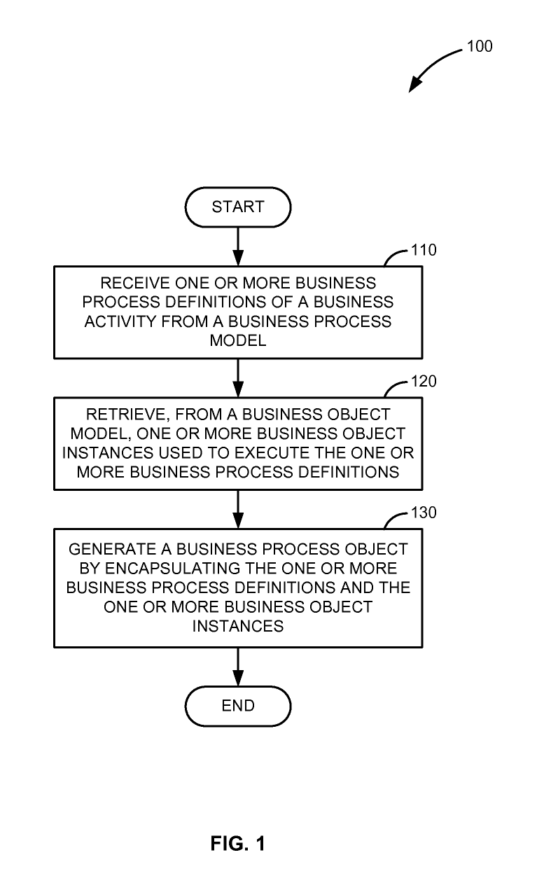

FIG. 1 is a flow diagram 100 illustrating a method for generating a business process object, according to an embodiment. At step 110, one or more business process definitions of a business activity are received from a business process model. The business process model includes one or more business process steps or business process definitions of the business activity. In other words, the business process model includes the business process definitions representing business processes of an enterprise. For example, considering an order-to-delivery business activity, business process definitions associated with the order-to-delivery business activity such as ‘generating sales order’ and ‘generating delivery’, which are included in the business process model, are received. In one exemplary embodiment, the business process definitions include corresponding user interfaces (UI) and the order of the UIs of the business process definitions ‘generating sales order’ and ‘generating delivery’.

At step 120, one or more business object instances used to execute the one or more business process definitions are retrieved from a business object model. In one embodiment, the business object model includes one or more business object instances on which the business process definitions can be executed. The business object instance includes business object definition and business object data of a business object. For example, considering the order-to-delivery business activity, the business objects such as ‘customer’, and ‘sales order’, which are used to execute the business process definition ‘generating sales order’ and ‘generating delivery’ are retrieved from the business object model.

At step 130, a business process object is generated by encapsulating the received one or more business process definitions and the retrieved one or more business object instances. For example, considering the order-to-delivery business activity, the business process definition such as ‘generating sales order’ and ‘generating delivery’, and corresponding business object instances such as ‘customer’ and ‘sales order’ are encapsulated in the business process object. Therefore, the business process object includes the business process definitions of a particular business activity and the business object instances.

In one embodiment, the business process object reflects the flow of modifications in the business object data and state of the business object such as ‘generated’, ‘modified’, ‘saved’, and the like. In other words, the business process object controls the status of the business objects as the business process object is a role owner of the retrieved business process instances (i.e., depending on the operations performed on the business objects, the status of the business objects are recorded at the business process object). For example, a ‘purchasing process’ business activity, which includes the business object instances ‘purchase order object’ and ‘supplier business object’, the status of the ‘purchase order object’ and ‘supplier business object’ are recorded by the business process object as per the changes occurring at each step of the ‘purchasing process’ business activity.

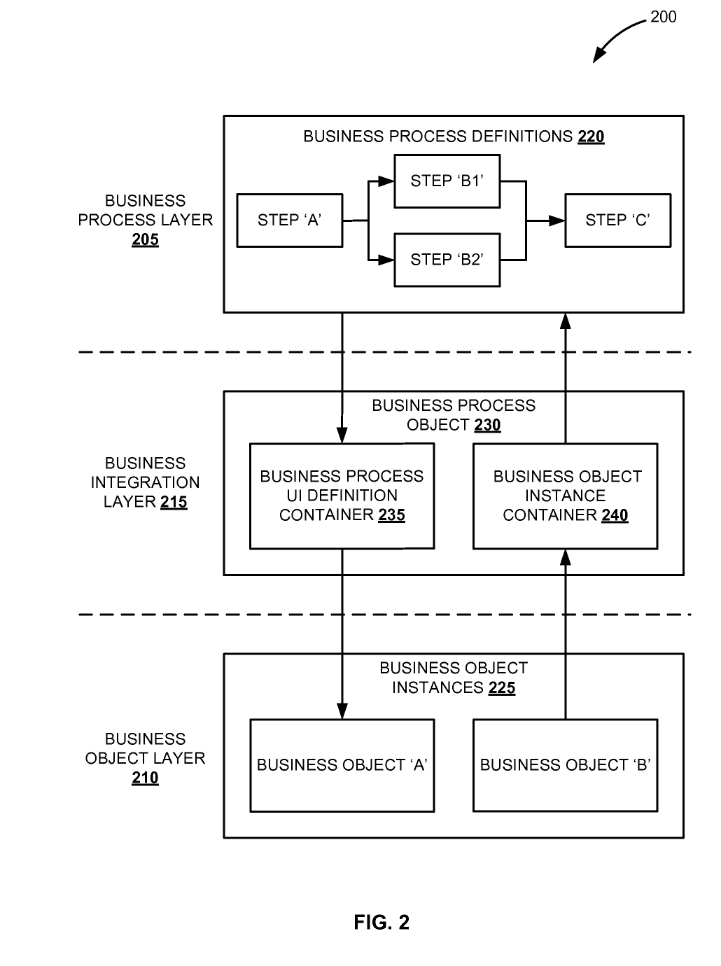

FIG. 2 is an exemplary architectural block diagram 200 to execute the method of FIG. 1, according to an embodiment. In one embodiment, the architecture includes a business process layer 205 and a business object layer 210, and a business integration layer 215 integrating the business process layer 205 and the business object layer 210. The business process layer 205 defines business process definitions 220 (e.g., step ‘A’, step B1′, step B2′ and step ‘C’) of a business activity. Further, the business process definitions 220 can include user interface (UI) elements corresponding to the business process definitions (e.g., the UI corresponding to the step ‘A’, step B1′, step B2′ and step ‘C’).

In one embodiment, the business object layer 210 defines business object instances 225 of one or more business objects (e.g., business object ‘A’ and business object ‘B’). Business objects corresponding to an enterprise, their attributes and relations are defined in the business object layer 210. Further, the business object instances include business object data to execute the business process definition. In operation, the business process definition may have to use different business object instances in parallel. Therefore, to allow the functionality of integrating the business process definitions and the business object instances, the business integration layer 215 is generated.

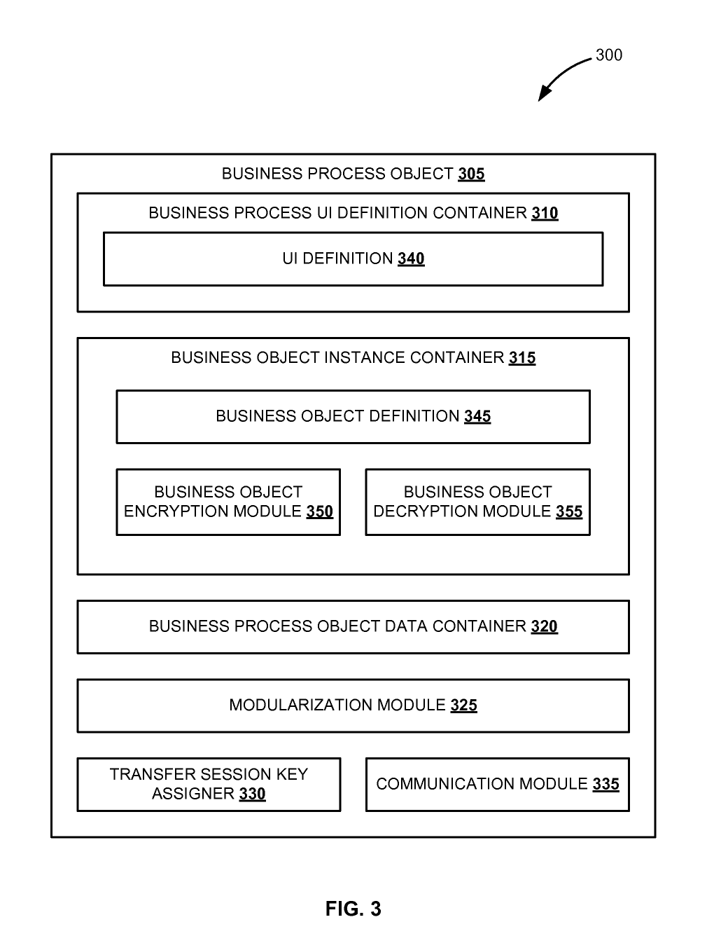

In one embodiment, the business integration layer 215 is generated to integrate the business process layer 205 and the business object layer 210. The business integration layer 215 defines a business process object 230. Further, the business process object 230 includes a business process user interface (UI) definition container 235 and a business object instance container 240. In one embodiment, the business process definitions 220 are received at the business process UI definition container 235. Further, the business object instances 225 used to execute the received business process definitions 220 are retrieved at the business object instance container 240. Therefore, the business process object 230 provides a bridge object between the business process layer 205 and the business object layer 210. Accordingly, the business process object 230 is a business object that collects business activity data which is declared in a particular business activity (i.e., the business process object includes business data used to perform particular business activity). The business process object is described in greater detail in FIG. 3.

FIG. 3 is a block diagram 300 illustrating a business process object 305, according to an embodiment. In one embodiment, the business process object 305 includes a business process user interface (UI) definition container 310, a business object instance container 315, a business process object data container 320, a modularization module 325, a transfer session key assigner 330, and a communication module 335.

In one embodiment, the business process UI definition container 310 includes business process definitions of a business activity. In one exemplary embodiment, the business process UI definition container 310 includes one or more user interface (UI) definitions 340 of the business process definition. For example, the business process UI definition container 310 includes a list of business process definition IDs, a list of UIs used in a particular business process definition, and the order of UI (e.g., used to define wizards). The list of UIs can include UI IDs and UI version numbers.

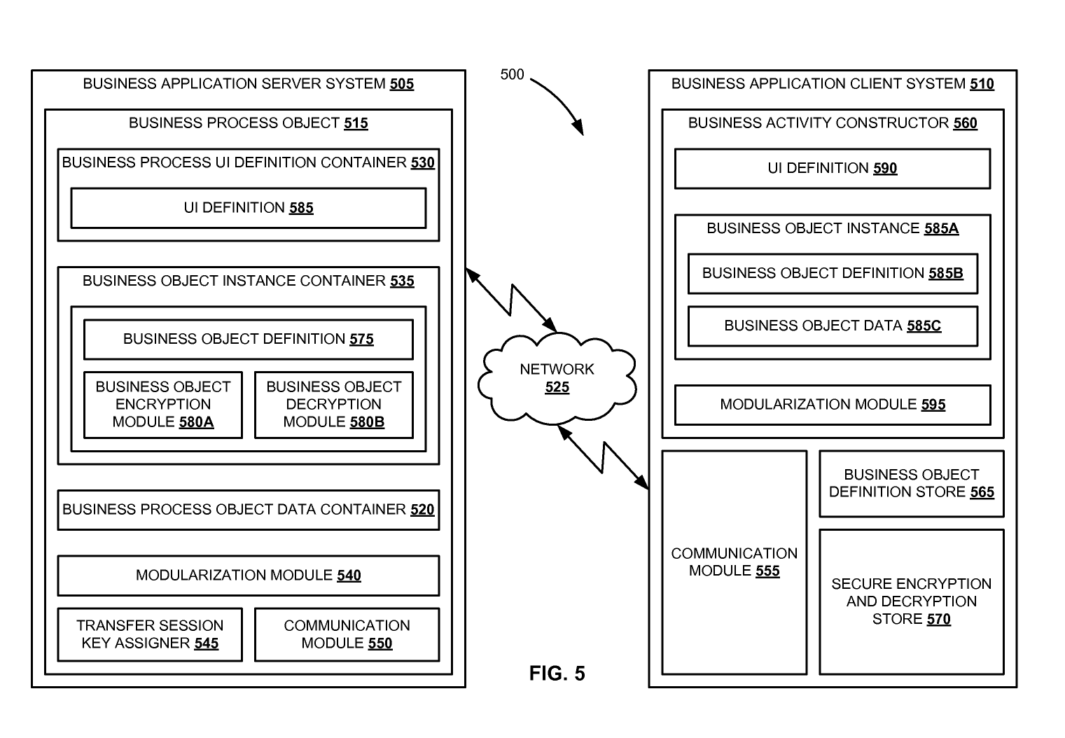

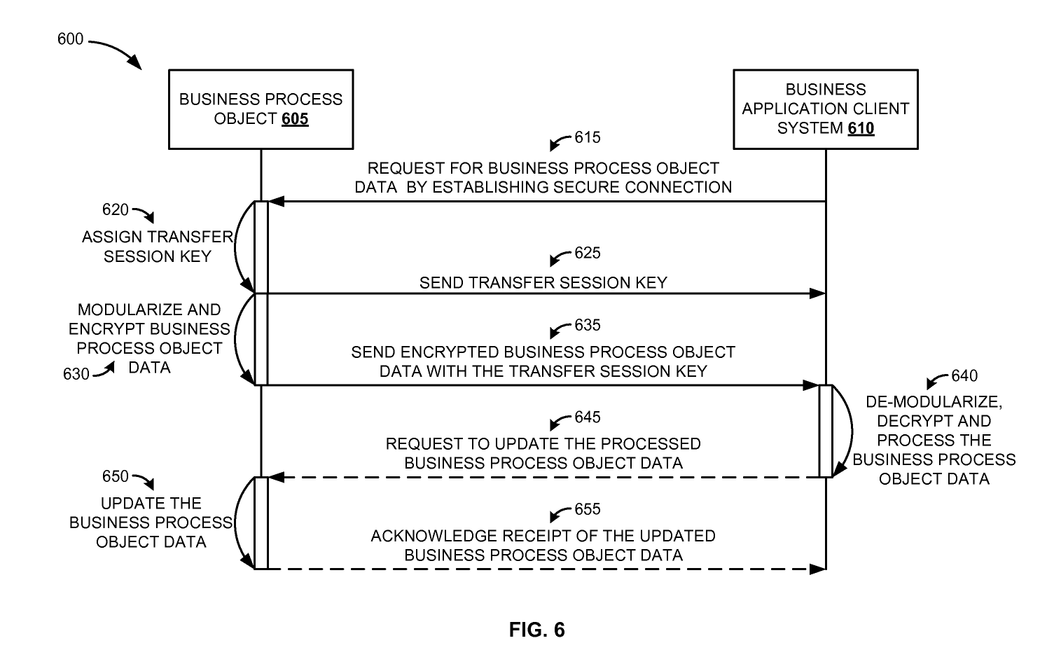

In one embodiment, the business object instance container 315 includes business object definition 345 to execute the business process definition. The business object instance container 315 further includes a business object encryption module 350 and a business object decryption module 355. The business object encryption module 350 is used to encrypt the business object data of the business object instance in a business object specific way of encryption to increase the security of the business object instance during transmission to a requested business application client system (as described in detail in FIGS. 5 and 6). The business object definition 345 includes a list of business objects to execute the business process definition. The business object definition 345 also includes a business object ID and business object version number associated with each business object.

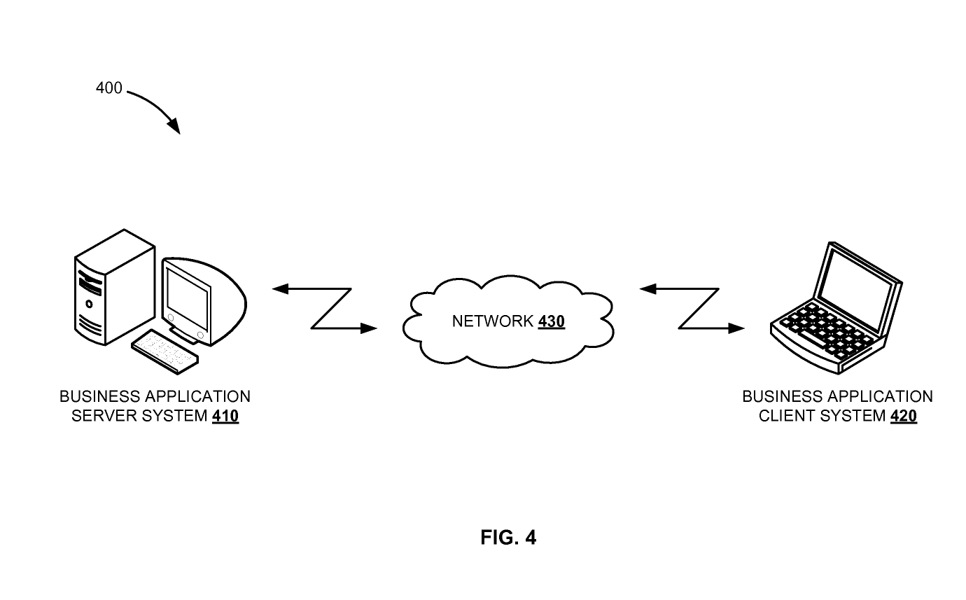

In one embodiment, the business process object data container 320 includes business data used to perform a particular business activity. The business process object data includes business object data ID (e.g., to identify the business object), a business object data version number, and a business object data source to identify the business data provider or a system that owns or provides the business object data. In one exemplary embodiment, the business process object can be generated in a business application server system. Further, the business process object can be moved or transferred to a business application client system. In one embodiment, the business process object data associated with the business process object can be securely transferred to a business application client system using the modularization module 325, a transfer session key assigner 330 and the communication module 335. The transmission of the business process object data from the business process object 305 to the business application client system is described in detail in FIGS. 4 to 6.

At design-time, the business process object is generated by encapsulating the business process definition and the business object using modeling and programming tools such as Business Process Modeling Notation (BPMN) and the like. Further, the business process object becomes the role owner of the retrieved business objects and also modifies the status of the respective business objects according to the business process steps. At runtime, the business process object data of the business process object is transferred to the business application client system using client specific secure data transfer (e.g., using a transfer session key), business object specific encryption and decryption methods, and modularized (i.e., to optimize the business process object data from performance perspective) data transfer (e.g., separate transfer of UI, business process object definition data and non-definition data of the business process object data), which is described in greater detail in rest of the description.

FIG. 4 is a block diagram 400 illustrating an overview of an integrating system for integrating business process and business objects associated with a business activity, according to an embodiment. In one embodiment, a business process object can be generated in a business application server system 410 as described in FIG. 1. Further, the business process object can be moved or transferred to a business application client system 420 from the business application server system 410 through a network 430.

In one exemplary embodiment, the business application server system 410 and the business application client system 420 may be described as computing systems installed on the network 430. The computing systems can be desktop computers, work stations, laptop computers, hand held computers, smart phone, console devices and similar portable computing systems. Further, a secure communication channel is established between the business application server system 410 and the business application client system 420 using the network 430. The network 430 can be a communication network including a local area network (LAN) and/or a wide area network (WAN), such as the internet or similar network. The network 430 may include wireless and/or wired communication mediums and enable networking devices (e.g., intermediate devices between the computing devices including network elements) and other computing devices to communicate with one another using the wireless or wired communication medium.

In one embodiment, the secure communication medium is established between the computing devices (between the business application server system and the business application client system, for instance) for establishing communication, exchanging information, detecting errors that may arise during communication, and the like. In one embodiment, business process object data in the business application server system 410 is transferred to the business application client system 420 using a transfer session key, business object specific way of encryption and decryption methods, and the modularization method. Transferring the business process object data is described in greater detail in FIGS. 5 and 6.

FIG. 5 is a block diagram 500 illustrating a system for transferring business process object data from a business process object 515 to a business application client system 510, according to an embodiment. In one embodiment, the business process object 515 is generated in a business application server system 505 as described in FIG. 1. Further, business process object data (e.g., stored in a business process object data container 520) of the business process object 515 is transmitted to the business application client system 510 to execute a business activity at the business application client system 510 using a secure communication network 525, at runtime. In one embodiment, the business process object data can be of any data type and of any format. The business process object data can include a document, business logic, program code or similar data. For example, the business process object data can be an extensible markup language (XML) document or hypertext markup language (HTML) document or similar document.

In one embodiment, the business process object 515 includes a business process UI definition container 530, a business object instance container 535, the business process object data container 520, a modularization module 540, a transfer session key assigner 545, and a communication module 550. Further, the business application client system 510 includes a communication module 555, a business activity constructor 560, a business object definition store 565, and a secure encryption and decryption store 570.

In operation, the business application client system 510 requests for the business process object data by establishing a secure communication medium with the business process object 515 using the network 525. Further, the transfer session key assigner 545 of the business process object 515 assigns a transfer session key specific to the business application client system 510. In one exemplary embodiment, the communication between the business process object 515 and the business application client system 510 includes the transfer session key specific to the business application client system 510, so that no one can hack the communication data between the business process object 515 and the business application client system 510.

Further in response to the request, the business object data in the business process object data container 520 is transferred to the modularization module 540 as an initial step in transmitting the business process object data to the business application client system 510 over the network 525. In one embodiment, business object instance data (e.g., business object definition 575 of the business object instance container 535) associated with a business process (e.g., user interface (UI) definitions 585 of the business process UI definition container 530) is first modularized (i.e., reduction of the business process object data amount). In other words, only the usable business object instance data is sent by the modularization module 540 and then encrypted using a business object specific way of encryption (e.g., the encryption module can use any encryption algorithm including block ciphers, streaming ciphers, public key cryptography algorithms such as RSA and similar encryption algorithms) by a business object encryption module 580A. A business object specific way of decryption corresponding to the business object specific way of encryption is communicated to the business application client system 510 using a business object decryption module 580B, the modularization module 540, the communication module 550, and the transfer session key.

In one embodiment, the modularization module 540 includes a data modularizer and a data key component. The data modularizer analyses the business process object data and determines the data type or format and separates the format data, metadata and similar data from the value data of the business process object data. For example, if the business process object data to be transmitted were an instance of an object, then the object class data would be separated from the particular values of the instance. The format data, metadata and similar data are placed in a definition file, while the remainder of the business process object data, becomes a non-formatted or non-typed set of the business process object data without any definition data. In other words, the business process object data is separated into a definition and non-definition data. The definition data is then passed to the message key component, which generates a key that is unique to the definition data. The data key component can use a hashing algorithm, message authentication code algorithm, or similar process for generating a unique key for any given definition data. The definition data, the non-definition data and the key of the business process object data are then passed to a communication module 550. The usage of modularization module 540 allows the business process object data optimization, this means a business object specific data conversion (e.g., zipping, byte modification, and the like) which guarantees the reduction of business process object data size and can be used as additional security element.

In one embodiment, the definition data, the non-definition data and the key are encrypted using encryption technologies such as symmetrical encryption, hybrid encryption, asymmetrical encryption or similar encryption technology before transmitting to the business application client system 510 through the network 525. Further, the communication module 550 transfers the encrypted definition data, the non-definition data and key to the business application client system 510 over the network 525. In one embodiment, the encrypted definition data, the non-definition data and the key are communicated to the business application client system 510 using the transfer session key. Also, these portions of the business process object 515 are separately transmitted as packets such that if any packet or similar component of the secure communication is intercepted by a third party, even if the encryption is broken, the third party is unable to obtain both the definition data and the non-definition data without the transfer session key. In one exemplary embodiment, the definition data is transferred only once since the definition data is same for all non-definition data.

Further in operation, in one embodiment, the communication module 555 of the business application client system 510 manages the establishment of the secure communication channel in conjunction with communication module 550 of the business process object 515. The communication module 555 receives the transfer session key and the business object specific way of encryption and decryption methods and stores in the secure encryption and decryption store 570. Further, the business object definition data of the business process object, which may be received once is stored in the business object definition store 565 and used for associated non-definition data of the definition data.

Further, the communication module 555 decrypts the received business process object data components including the definition data, the non-definition data, the key and the transfer session key using the same algorithm or a mirror of the algorithm used by the encryption module of the communication module 550 of the business process object 515. In one embodiment, the decrypted definition data and the non-definition data are then passed to the business activity constructor 560. The business activity constructor 560 utilizes an algorithm that is a mirror or inversion of the modularization module 540 to merge the definition data and the non-definition data to reform the original business process object data (e.g., business object instance 585A including business object definition 585B and business object data 585C corresponding to user interface (UI) definition 590) using a modularization module 595 of the business application client system 510. The reformed business process object data is then passed on to the application or program to which it is addressed for further processing based on the nature of the business process.

In general, the business object data in the business process object is encrypted and decrypted using business object specific way of encryption and decryption methods and the business object data is transferred using the transfer session key specific to the business application client system. This process guarantees that only the business application client system that uses the right transfer session key and respective business object specific decryption method may decrypt the business process object data. The interaction between the business process object and the business application client system is described in greater detail in FIG. 6.

FIG. 6 is a sequence diagram 600 illustrating a data flow for transferring business process object data from a business process object 605 to a business application client system 610, according to an embodiment. The sequence diagram of FIG. 6 represents the interactions and the operations involved between the business process object 605 and the business application client system 610. The sequence diagram 600 depicts process objects including the business process object 605 and the business application client system 610 along with respective vertical lines originating from them. The respective vertical lines of the business process object 605 and the business application client system 610 represent the process that may exist simultaneously. The horizontal arrows (e.g., 615, 625 and 635) represent the data flow between the vertical lines originating from their respective process objects (e.g., the business process object 605 and the business application client system 610). The dotted horizontal arrows (e.g., 645 and 655) represent optional data flow between the vertical lines originating from their respective process objects (e.g., the business process object 605 and the business application client system 610). Activation boxes (e.g., 620, 630, 640 and 650) between the horizontal arrows represent the process that is being performed in the respective process object (e.g., the business process object 605 and the business application client system 610).

In one embodiment, at step 615, the business application client system 610 requests for business process object data by establishing a secure connection with the business process object 605. At activation box 620, a transfer session key specific to the business application client system 610 is assigned by the business process object 605 and the assigned transfer session is sent to the business application client system 610, in step 625. The transfer session key is stored at the business application client system 610 to identify the business process object data received from the business process object 605.

At activation box 630, in response to the request made at step 615, the business object instance data is modularized and encrypted. After modularizing, the business object instance data is encrypted using a business object specific way of encryption. At step 635, the encrypted business process object data is transferred to the business application client system 610 using the transfer session key. Further, the received encrypted business process object data is decrypted, de-modularized, and processed at the business application client system 610, at activation box 640. Thereby, the business application client system 610 is independent of the business application server system as the business application client system 610 includes the data to execute the business process and therefore the business application client system 610 can work in offline mode. In one exemplary embodiment, the business application client system 610 may communicate with the business application server system only if a new version of the business object data is needed.

Furthermore in process, the business application client system 610 can send a request to update the processed business process object data at the business process object 605, optionally at step 645. Upon receiving the request for updating, the business process object 605 updates the business process object data with the processed business process object, at activation box 650. Further, an acknowledgement of the updated business process object data is sent for stating completion of the transaction, in step 655.

The business process object allows integration of the data used in a business process and provided by business object(s). Further, the integration of occurrence (i.e., status) in business process modeling and runtime business process object representation defines how the business process flows from one to other state (e.g., each step of the business process). In other words, the business process object allows the modeling of the flow-oriented objects that includes the business related data and provides solution for the business data integration, therefore allowing a better and smooth integration of business process and business object related business activities.

In addition, the usage of business object related security elements, for example, business object specific encryption and decryption methods, modularization module and additional usage of business application client specific transfer session key guarantees a highly efficient and secure processing of business process. The storing of the encryption and decryption methods in encrypted form (e.g., using transfer session key) in secure store, additionally increase the security aspect, which is especially important for the advanced insider who may have access to part of information. Therefore, allowing a secure processing of business processes in modern business applications, which are dealing with high sensitive business data (e.g., strategic planning or banking system) and running on different systems integrated in business process platform (e.g., business application running on a service oriented architecture (SOA)).

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

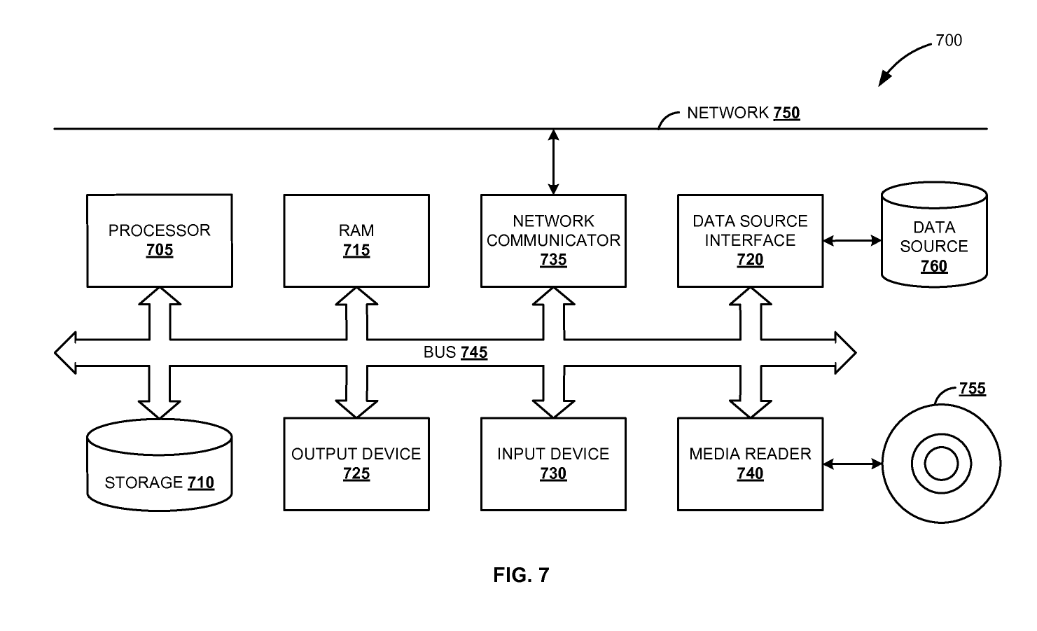

FIG. 7 is a block diagram of an exemplary computer system 700. The computer system 700 includes a processor 705 that executes software instructions or code stored on a computer readable storage medium 755 to perform the above-illustrated methods of the invention. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. The stored instructions may be further compiled to generate other representations of the instructions and dynamically stored in the RAM 715. The processor 705 reads instructions from the RAM 715 and performs actions as instructed. According to one embodiment of the invention, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a tangible computer readable storage medium to physically store instructions, which when executed by a computer, cause the computer to:
receive one or more business process definitions of a business activity from a business process model;
retrieve, from a business object model, one or more business object instances used to execute the one or more business process definitions; and
generate a business process object by encapsulating the received one or more business process definitions and the retrieved one or more business object instances.

2. The article of manufacture of claim 1, wherein the one or more business object instances comprises corresponding business object definition and business object data.

3. The article of manufacture of claim 1, wherein the business process object modifies business object data and a business object state of the one or more business object instances.

4. The article of manufacture of claim 1, further comprising instructions to cause the computer to transfer business process object data associated with the business process object to a business application client system.

5. The article of manufacture of claim 4, wherein transferring the business process object data comprises:
receiving a request, at the business process object, for the business process object data from the business application client system;
assigning a transfer session key specific to the business application client system;
encrypting business object data in the business process object in a business object specific way of encryption; and
transferring business process object data to the business application client system using the transfer session key.

6. The article of manufacture of claim 5, wherein transferring the business process object data comprises modularizing the business process object data to separate definition and non-definition data of the business process object and encrypting the modularized business process object data.

7. The article of manufacture of claim 4, further comprising receiving the business process object data at the business application client system.

8. The article of manufacture of claim 7, wherein receiving the business process object data further comprises decrypting the received business process object data using the transfer session key, business object specific decryption method, and de-modularizing the business process object data to combine definition and non-definition data of the business process object data.

9. A computer implemented method to generate a business process object, the method comprising:
receiving one or more business process definitions of a business activity from a business process model;
retrieving, from a business object model, one or more business object instances used to execute the one or more business process definitions; and
generating the business process object by encapsulating the received one or more business process definitions and the retrieved one or more business object instances.

10. The computer implemented method of claim 9, wherein the one or more business object instances comprises corresponding business object definition and business object data.

11. The computer implemented method of claim 9, wherein the business process object modifies business object data and a business object state of the one or more business object instances.

12. The computer implemented method of claim 9, further comprising instructions to cause the computer to transfer business process object data associated with the business process object to a business application client system.

13. The computer implemented method of claim 12, wherein transferring the business process object data comprises:
receiving a request, at the business process object, for the business process object data from the business application client system;
assigning a transfer session key specific to the business application client system;
encrypting business object data in the business process object in a business object specific way of encryption; and
transferring business process object data to the business application client system using the transfer session key.

14. The computer implemented method of claim 13, wherein transferring the business process object data comprises modularizing the business process object data to separate definition and non-definition data of the business process object and encrypting the modularized business process object data.

15. The computer implemented method of claim 12, further comprising receiving the business process object data at the business application client system.

16. The computer implemented method of claim 15, wherein receiving the business process object data further comprises decrypting the received business process object data using the transfer session key, business object specific decryption method, and de-modularizing the business process object data to combine definition and non-definition data of the business process object data.

17. An integration system to integrate business process oriented and business object based business activities, the integration system comprising:
a business application client system including a processor communicating with one or more memory devices; and
a business application server system communicatively coupled to the business application client system via a network, the business application server system including a business process, wherein the business process object comprises:
a business process user interface (UI) definition container to receive one or more business process definitions of a business application from a business process model;
a business object instance container to retrieve one or more business object instances used to execute the one or more business process definition from a business object model;
a business process object data container to encapsulate the received one or more business process definitions and the retrieved one or more business object instances;
a modularization module to modularize business process object data of the business process object data container; and
a communication module to transfer the modularized business process object data to a business application client system.

18. The integration system of claim 17, wherein the business process object further comprises a transfer session key assigner to assign a transfer session key specific to the business application client system, and a business object encryption and decryption module to encrypt business object data before transferring to the business application client system.

19. The integration system of claim 17, wherein transferring the modularized business process object data comprises:
receiving a request, at the business process object, for the business process object data from the business application client system;
assigning a transfer session key specific to the business application client system;
encrypting business object data in the business process object in a business object specific way of encryption; and
transferring business process object data to the business application client system using the transfer session key.

20. The integration system of claim 19, wherein the business application client system comprises:
a communication module to receive the business process object data; and
a business activity constructor to decrypt the received business process object data using the transfer session key and business process object specific decryption method, and de-modularize the business process object data to combine definition and non-definition data of the business process object data.
